(19) United States
(12) Patent Application Publication
(10) Pub. No.: US 2004/0238366 A1
(43) Pub. Date: Dec. 2, 2004

(54) Method and system with apparatus for acceleration of activity decrease and radioactive material deactivation

(76) Inventors: Kinderevich Anatoly Vladimirovich, Kiev (UA); Kicha Leonid Ivanovich, Kiev (UA)

Correspondence Address: MARK M. TAKAHASHI, GRAY CARY WARE & FREIDENRICH, LLP, 4365 EXECUTIVE DRIVE, SUITE 1100, SAN DIEGO, CA, 92121-2133, US

(21) Appl. No.: 10/453,681

(22) Filed: Jun. 2, 2003

(51) Int. Cl. G21F 9/00; C25B 1/00; C25C 1/22; C25C 3/34

(52) U.S. Cl. 205/43; 588/1; 204/230.2; 204/242

(57) ABSTRACT

Radioactive material can be processed by an apparatus that includes at least a cylindrical outer shell electrode, an inner electrode, and a plurality of prism-shaped ferromagnetic elements positioned between the outer and inner electrodes. The prism-shaped ferromagnetic elements are positioned around the inner circumference of the metal cylinder. The inner electrode component is located within the metal cylinder and is configured to cover the inwardly-pointing portions of the prism-shaped ferromagnetic elements. Radioactive material in a container is placed into the apparatus, and an AC voltage excitation signal is applied to the electrodes of the apparatus during treatment of the material. The frequency of the excitation signal is selected according to the frequency of structurization or the frequency of destructurization of the ferromagnetic material. The process can be monitored and controlled with the use of alpha, beta, and gamma radiation intensity measuring instruments.

### FIELD OF THE INVENTION

The present invention relates generally to the field of applied physics, and deals with the acceleration of processes of activity decrease and deactivation of radioactive materials of high and low activity levels. More particularly, the present invention relates to the treatment of radioactive material such as waste from nuclear power plants.

### BACKGROUND OF THE INVENTION

Worldwide development of nuclear power engineering has created a problem that is progressively turning into a global ecological issue. Namely, this problem relates to the accumulation, processing, and storing of radioactive waste materials. The United States, France, and Russia process the nuclear waste that has accumulated over time. Such processing is partial in that only five or six isotopes are returned into the new fuel cycle, while other isotopes are no longer suitable for utilization.

There are approximately 50 actinides accumulated in every nuclear reactor at the end of each operating period, and 20 of the actinides are long-living isotopes that remain highly radiotoxic despite long periods of aging. Such nuclear waste is typically stored in special containers buried deep below the surface of the earth; nevertheless, this storage method can be the source of ecological problems and the subject of controversy and concern. Existing processing technologies for radioactive waste are very expensive, laborious, not environmentally safe, and are time consuming.

Consequently, there exists a need for new techniques of acceleration of the processes of activity decrease and deactivation of radioactive material (hereinafter referred to as “treatment” of radioactive material).

### BRIEF SUMMARY OF THE INVENTION

The method of activity decrease and deactivation of radioactive materials uses a system that includes an apparatus for treatment of radioactive material configured to function as a large hollow capacitor having a ferromagnetic material in lieu of a dielectric material. The system includes a power source, such as a signal generator that supplies a suitable AC voltage of adjustable frequency to the apparatus. A container with radioactive material is placed into the cavity of the apparatus, an appropriate frequency is selected for the signal generator, and the AC voltage at the selected frequency is applied to the apparatus until activity of the radioactive material is decreased to the permissible level or until complete deactivation has occurred. These processes are monitored with alpha, beta, and gamma meters.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic block diagram of a system for treating radioactive material;

FIG. 2 is a longitudinal sectional view of an apparatus for treating radioactive material;

FIG. 3 is a cross sectional view of the apparatus shown in FIG. 2, as viewed from line 3-3; and

FIG. 4 is a sectional view of a portion of the apparatus, showing the direction of the emitted flows focusing.

### DETAILED DESCRIPTION OF A PREFERRED EMBODIMENT

It should be appreciated that the particular implementations shown and described herein are illustrative of the invention and its best mode and are not intended to otherwise limit the scope of the invention in any way. Indeed, for the sake of brevity, conventional aspects of the systems (and the individual operating components of the systems) may not be described in detail herein. Also, dimensions of components of the apparatus of radioactive material treatment, which differ in each specific case of application, are not provided.

The term “radioactive material” as used herein comprises all wastes contaminated with radioactive substances in the quantities exceeding the established standards and rules. Solid wastes are considered radioactive if specific medical exploitation dose at the distance of 1 centimeter from the given waste exceeds 0.84 milliroentgen hour per kilogram or specific activity exceeds 2×10⁻⁶ and 1×10⁻⁸ Ci/kg (7×10⁴ and 3.7×10² Bq/kg), respectively, for beta- and alpha-active and transuranium elements. All radioactive isotopes, nuclear wastes can be conventionally subdivided into highly active, when specific activity amounts to 10¹⁵-10¹⁴ Bq/kg, medium active, 10¹³-10⁹ Bq/kg, low active, 10⁸ Bq/kg.

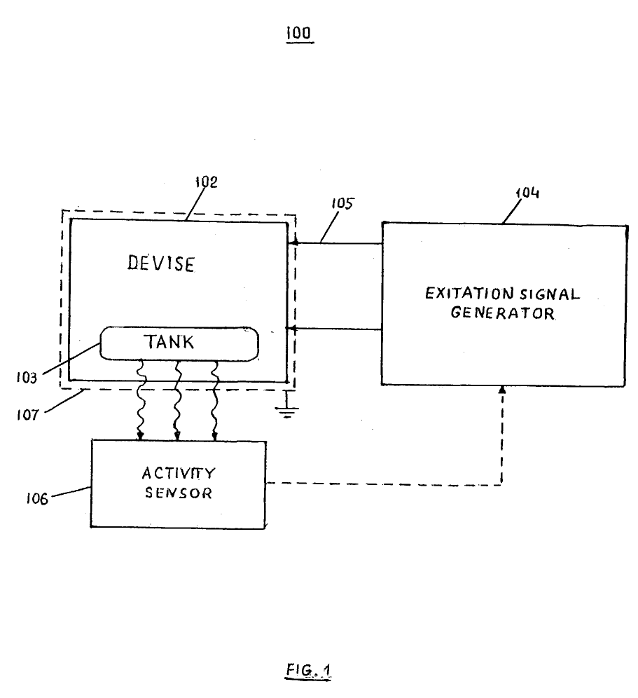

FIG. 1 is a schematic block diagram of a system 100 for the treatment of radioactive material. System 100 includes at least the following components: a treatment apparatus 102 configured as a hollow capacitor of complicated shape which holds a container (capsule) 103 for holding radioactive material; an excitation signal generator 104 connected to the treatment apparatus 102 with a high frequency cable 105; one or more alpha-, beta-, and gamma-activity sensors 106 located in the container; and a grounded shielding device 107. The dashed line in FIG. 1 indicates that the activity sensor 106 may, but need not, be connected to the generator 104 for purposes of feedback control.

The treatment apparatus 102 is generally configured as a special capacitor having an external shell electrode and an inner electrode. In lieu of a conventional dielectric material, the treatment apparatus 102 utilizes a ferromagnetic material located between the two electrodes. The treatment apparatus 102 includes a cavity formed therein; the cavity receives the container (capsule) with radioactive material. The container is positioned inside of the cavity during treatment of the material.

The adjustable generator 104 is connected to the electrodes of the capacitor 102, and is used for supplying AC voltage of suitable frequency, at which the so-called flows of structurization or destructurization are excited in the ferromagnetic and focused inside of the apparatus. These flows cause deceleration or acceleration of radioactive decay and spontaneous radioactive decay in the container.

Meters 106, which can be off-the-shelf commercially available instruments, are used to measure the intensity of alpha-, beta-, and gamma-radiation of the radioactive materials in the container. The readings of these detectors are used for monitoring of the technological process.

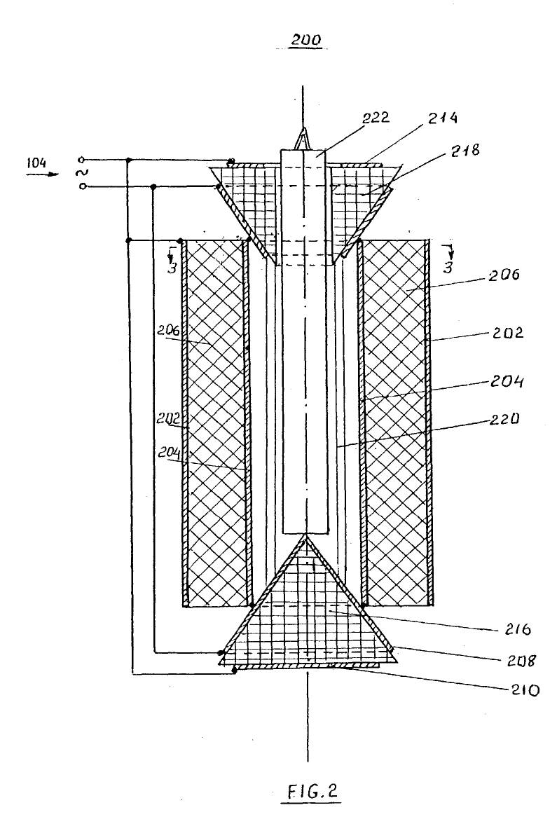

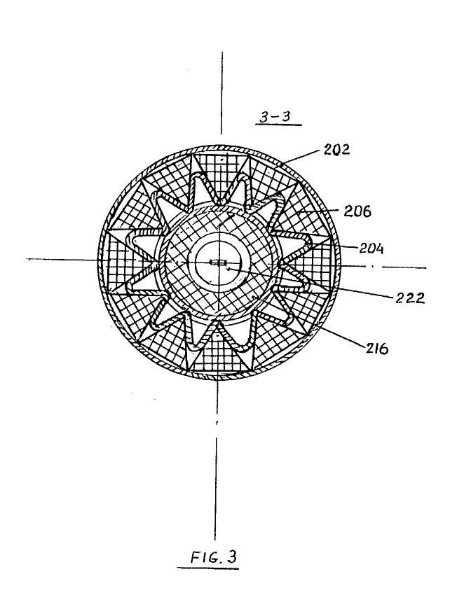

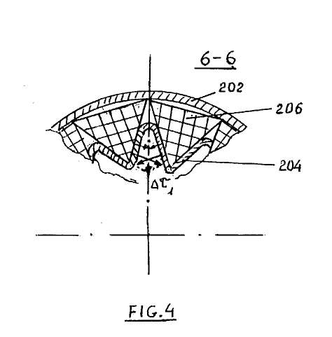

FIGS. 2 and 3 are views of sections of an apparatus 200 for treating radioactive material. FIG. 2 is a longitudinal sectional view of apparatus 200, as viewed from line 2-2 in FIG. 3 (line 2-2 represents a line that intersects the longitudinal axis of apparatus 200), and FIG. 3 is a cross sectional view of apparatus 200, as viewed from line 3-3 in FIG. 2. FIG. 4 is a cross sectional view of a portion of the apparatus, which shows the direction of the excited flows (of structurization or destructurization) focusing.

Apparatus 200 generally includes an outer shell electrode 202, an inner electrode 204, a plurality of ferromagnetic prisms 206, a first inner end electrode 208, a first outer end electrode 210, a second inner end electrode 212, a second outer end electrode 214, a first ferromagnetic end element 216, and a second ferromagnetic end element 218.

Outer shell electrode 202 may be cylindrical in shape. Other shell shapes may be utilized in alternate embodiments, e.g., polyhedron, spherical, or the like, as long as the shape facilitates proper focusing of the space-time flows. Outer shell electrode 202 is formed from an electrically conductive material such as metal. Although the preferred practical embodiment employs an outer electrode formed from stainless steel, other materials such as copper, zinc, or a suitable alloy can be utilized. The inner surface of electrode 202 defines the interior of electrode 202. The size of outer shell electrode 202 may vary to accommodate the particular application.

The ferromagnetic prisms 206 are positioned within the interior of outer shell electrode 202 and around the inner surface of outer shell electrode 202, as shown in FIG. 3. The prisms 206 are held in place in any suitable manner. For example, they can be glued to the inner electrode 204 such that electrical contact is maintained between the prisms 206 and the electrodes. In accordance with one practical embodiment, each ferromagnetic prism 206 has a triangular cross section (see FIG. 3). The triangular cross section includes an acute angle that forms an apex that points toward the interior of the apparatus. In this embodiment, each prism-shaped element 206 is identical in size, shape, and composition. The shape of the ferromagnetic prisms 206 facilitates the combination of the vectors of space-time flows generated by the prisms 206. The shape ensures that the resulting flows are directed toward the center of the cavity within the treatment apparatus.

In the example embodiment, the cylindrical shell electrode 202 and each of the ferromagnetic prisms 206 are of the same length. As shown in FIG. 3, each of the ferromagnetic prisms 206 is positioned within the interior of the outer electrode 202 such that its apex points toward the longitudinal center of treatment apparatus 200. In other words, all of the triangles defined by the cross sections of the prisms point radially inward. The number of ferromagnetic prisms 206, and their shape, size, and composition, may vary depending upon the particular application. Practical embodiments include at least three prism elements. In the illustrated example, apparatus 200 includes twelve prism-shaped elements 206 positioned around the inner surface of outer shell electrode 202 such that adjacent prisms contact each other at their respective bases.

The prism-shaped elements 206 should be formed from a ferromagnetic material. One suitable material is identified as material catalog number 250 VNRP according to the Ukraine National Nomenclature. 250 BHPΠ is nickel-zinc ferromagnetic. It has the following technological characteristics: (1) specific magnetization saturation: σᵢ=50-80 A*m²/kg; (2) coefficient of shrinkage: in the limits of 1.14-1.18; (3) initial magnetic permeability: μ_{H}=180-400; maximal allowable operation temperature: not less than 120° C. The material is generally characterized as a high frequency (10-100 MHz) ferromagnetic material. In this regard, ferromagnetic materials of low and super-high frequency are not desirable in this application.

The inner electrode 204 is formed from an electrically conductive material, such as metal. Although the preferred practical embodiment employs an inner electrode formed from stainless steel, other materials such as copper, zinc, an alloy, or any current-conducting material can be utilized. The inner electrode 204 is located within the interior of the shell electrode 202, and is coupled to the ferromagnetic prisms 206 such that the prism-shaped elements 206 are not exposed to the interior. In this regard, the ferromagnetic material is located between the inner surface of the shell electrode 202 and the inner electrode 204. The inner electrode 204 is configured such that it does not contact the outer shell electrode 202. In the practical embodiment, the inner electrode 204 may be realized as a plurality of flat plates that are joined together at points between the prisms 206 and at the apexes of the prisms 206. Alternatively, the inner electrode 204 may be formed as a unitary component.

The inner electrode 204 is held in place in any suitable manner, for example, by gluing or welding it to the prism shaped elements 206. As shown in FIGS. 2 and 3, the inner electrode 204 defines a cavity 220 within the interior of the treatment apparatus 200. The cavity 220 is shaped to accommodate the container 222 in which the radioactive material is placed. The container 222 is formed as a cylindrical vessel in which radioactive material is sealed. In a practical embodiment, the container 222 is preferably formed of lead because lead screens alpha, beta, and gamma radiation while allowing the space-time flows to pass. Although not shown, the container 222 rests on dielectric or insulating plates or mounts to ensure that the container 222 is electrically isolated from the inner electrode 204 during processing of the radioactive material.

The first inner end electrode 208 is formed from an electrically conductive material. The first inner end electrode 208 is connected to one end of the inner electrode 204 to establish electrical continuity. In the example embodiment, the first inner end electrode 208 is a conical shell electrode that contacts the inner electrode 204 at the inwardly facing points. In this regard, the first inner end electrode 208 is physically attached to the inner electrode at these points. In practice, these two electrodes can be connected together (by welding, soldering, etc.).

The exact dimensions and configuration of first inner end electrode 208 may vary from one system to another. Generally, the dimensions of the first inner end electrode 208 are proportional to the dimensions of the Egyptian pyramids.

First ferromagnetic end element 216 is mounted in the first inner end electrode 208 as shown in FIG. 2. The end element 216 may be welded, bonded, or otherwise secured to the first inner end electrode 208. The end element 216 is preferably formed from the same ferromagnetic material used for the prism-shaped elements 206. In this example, the end element 216 is cone-shaped, which allows it to mate with conical shell electrode 208. Generally, the dimensions of the first ferromagnetic end element 216 are proportional to the dimensions of the Egyptian pyramids. The height of the first ferromagnetic end element 216 may be greater than the height of the first inner end electrode 208, as depicted in FIG. 2 and FIG. 5. This feature facilitates the focusing properties of the apparatus.

The first outer end electrode 210 is mounted to the outer surface of the first ferromagnetic end element 216 such that electrode 210 does not contact the first inner end electrode 208. The first outer end electrode 210 may be glued or otherwise secured to the outer surface of the end element 216. The first outer end electrode 210 is formed from an electrically conductive material. As schematically shown in FIG. 2, the first outer end electrode 210 is electrically connected to the outer shell electrode 202 and to the second outer end electrode 214. This electrical connection may be established using wire, cabling, or any suitable electrical conductor.

The exact dimensions and configuration of first outer end electrode 210 may vary from one system to another. In accordance with one practical embodiment, the first outer end electrode is a circular plate. The diameter of the first outer end electrode 210 may be less than the base diameter of the first ferromagnetic end element 216, as depicted in FIG. 2.

The second inner end electrode 212 is also formed from an electrically conductive material. The second inner end electrode 212 is connected to the end of the inner electrode 204 (opposite the first inner end electrode) to establish electrical continuity. Thus, the first inner end electrode 208, the second inner end electrode 212, and the inner electrode 204 cooperate to form one electrode component. In the example embodiment, the second inner end electrode 212 is a truncated conical shell electrode that contacts the inner electrode 204 at its inwardly facing points. In this regard, the second inner end electrode 212 can be physically attached to the inner electrode 204 at these points, in the same manner as described above for the first inner end electrode 208. In this example, the truncated tip forms an opening in the second inner end electrode 212. As shown in FIG. 2, this opening is positioned within the interior of the outer shell electrode 202. The exact dimensions and configuration of second inner end electrode 212 may vary from one system to another.

Second ferromagnetic end element 218 is mounted in the second inner end electrode 212 as shown in FIG. 2. The end element 218 can be glued or otherwise secured to the second inner end electrode 212. The ferromagnetic end element 218 should be formed from the same ferromagnetic material used for the prism-shaped elements 206. In this example, the end element 218 is shaped like a truncated cone, which allows it to mate with second inner end electrode 212. The height of the second ferromagnetic end element 218 may be greater than the height of the second inner end electrode 212, as depicted in FIG. 2.

As shown in FIG. 2, the second ferromagnetic end element 218 has a conduit or passageway formed therein along its central axis. In the example embodiment, this conduit is a cylindrical hole having a diameter that is large enough to allow for passage of the container 222.

The second outer end electrode 214 is mounted to the outer surface of the second ferromagnetic end element 218 such that electrode 214 does not contact the second inner end electrode 212. The second outer end electrode 214 is formed from an electrically conductive material. As schematically shown in FIG. 2, the second outer end electrode 214 is electrically connected to the outer shell electrode 202 and to the first outer end electrode 210. This electrical connection may be established using wire, cabling, or any suitable electrical conductor. Thus, the first outer end electrode 210, the second outer end electrode 214, and the outer shell electrode 202 cooperate to form one outer electrode component.

As shown in FIG. 2, the second outer end electrode 214 has a hole formed therein. This hole is sized to accommodate canister 222. The hole is positioned for alignment with the conduit formed in the second ferromagnetic end element 218. Thus, the opening formed by the truncated tip of the second inner end electrode 212, the conduit in the second end element 218, and the hole in the second outer end electrode 214 form a passageway for the radioactive material, which may be enclosed within the container 222.

The exact dimensions and configuration of the second outer end electrode 214 may vary from one system to another. In accordance with one practical embodiment, the second outer end electrode 214 is a ring-shaped plate. The outer diameter of the second outer end electrode 214 may be less than the base diameter of the second ferromagnetic end element 218, as depicted in FIG. 2.

The generator of the excitation signal 104 is shown in FIG. 1; it is connected to the second outer end electrode 214, to the second inner end electrode 212, as shown in FIG. 2.

### Theory of Operation

The basis of the proposed method is constituted by the phenomenon of excitation of flows of structurization, Δτₗ, and destructurization, Δτ₂, in substance. Its physical substantiation is based upon the frequencies of proton nuclear magnetic resonance (NMR) in the phases of dispersion (J. W. Emsley, J. Feeney, and L. H. Sutcliffe, HIGH RESOLUTION NUCLEAR MAGNETIC SPECTROSCOPY, in two volumes, New York (1966)). Dispersion phase at NMR is a state of transition from the frequency of structurization to the frequency of destructurization or vice versa. In the chart showing energy absorption in NMR, crossing of the abscissa will be present without failure. This phenomenon characterizes dispersion.

It is established that when exposed to electromagnetic oscillations of specific frequency fᵢ, the substance, absorbing the energy of these oscillations, emits the flows of structurization, Δτ₁. At this, chemical shift takes place; and the substance somewhat decreases its sizes (isomerism). At the frequency of oscillations f₂, the substance emits the flows of destructurization, Δτ₂. At this, chemical shift takes place; and the substance somewhat increases its sizes (isomerism).

The frequency of structurization f₁, is defined as such a frequency of electromagnetic oscillations that ferromagnetic material, when exposed to it, as a result of nuclear magnetic resonance, emits the flows of space-time Δτ₁ that cause the phenomenon of structurization and dilation of any physical process. The frequency of destructurization f₂ is defined as such a frequency of electromagnetic oscillations that ferromagnetic material, when exposed to it, as a result of nuclear magnetic resonance, emits the flows of space-time Δτ₂ that cause the phenomenon of destructurization and acceleration of any physical process (A. B. [symbol] , [symbol] . [symbol] , [symbol] [symbol] . [symbol] [symbol] [symbol] , [symbol] ., 2000r. (A. V. Kinderevich, L. I. Kicha, FIELD THEORY. ELEMENTS OF NUMBERS THEORY, Kyiv 2000)—pp. 405-408). The reaction of the space-time flows effect is measured by N. A. Kozyrev detector, which is considered in the works: [symbol] H. A.// [symbol] [symbol] [symbol] [symbol] [symbol] [symbol] . AH. APM. CCCP, 1997r. (Kozyrev N. A., ASTRONOMICAL OBSERVATIONS BY THE WAY OF PHYSICAL PROPERTIES OF TIME, Academy of Sciences of Armenian SSR (1977)); [symbol] H. A., [symbol] B. B.// [symbol] [symbol] [symbol] , 1980r. (Kozyrev N. A., Nasonov V. V., PROBLEMS OF UNIVERSE STUDIES (1980)); [symbol] M. M., [symbol] [symbol] . A., [symbol] M. [symbol] .// [symbol] CCCP, 1990r., c.314 (Lavrentyev M. M., Yeganova I. A., Lutset M. K., Doklady Akademyy Nauk USSR, (1990), p. 314).

In the monograph A. B. [symbol] , [symbol] . [symbol] , [symbol] [symbol] . [symbol] [symbol] [symbol] , [symbol] ., 2000r. (A. V. Kinderevich, L. I. Kicha, FIELD THEORY. ELEMENTS OF NUMBERS THEORY, Kyiv (2000)), it is shown that any substance affects the flows Δτ₂ emitted by some mass very insignificantly; and it is essentially transparent for them. However, insignificant fraction of these flows deflects at specified angle when passing from a less dense substance to a denser one. This could result in appearance of some resemblance of static lenses of Δτ₂ focusing, which have real and imaginary focuses, and, consequently, in local thickening of the space-time flows and their rarefication, which is related to the Hubble number, H, changes in this local region, acquiring the magnitude H₁. The normal intensity of the physical processes is determined by the Hubble constant:

$$H = 2.8 \times {10}^{- 18} \frac{1}{c} .$$

If the flows density increase takes place, then in this local region H₁>H, if the flows rarefication takes place, then H₁<H. Relation

$$\frac{{H}_{1}}{H}$$

is an attribute of the local region: at

$$\frac{{H}_{1}}{H} > 1$$

destructurization takes place, at

$$\frac{{H}_{1}}{H} < 1$$

structurization takes place. It is substantiated theoretically that the larger the flow Δτ₂, the smaller will be structurization at the given point of the Earth surface.

This is explained by the fact that the values Δτ₂ and

$$\frac{{H}_{1}}{H}$$

are linked by the relation

$$Δ {t}_{2} = \frac{0.5 \sqrt{\frac{{H}_{1}}{H}} M}{4 π {R}_{E}^{2}} ,$$

where M=const, R_{E} is the radius of Earth. From here, it is seen that when the value

$$\frac{{H}_{1}}{H} > 1$$

increases at given point of “Earth-Universe” destructurization will increase and vice versa at

$$\frac{{H}_{1}}{H} < 1.$$

It is shown that the change of the magnitude of the activity, A, of radioactive materials at the initial specific activity A₀=(10⁸÷10¹⁵) Bq/kg equals to:

$$A = {A}_{0} {ⅇ}^{- \frac{H}{{H}_{1}} λ t} , \qquad ( 1 )$$

where λ is the decay constant, t is time.

It could be easily noted that at the specific magnitudes of the value

$$\frac{{H}_{1}}{H} ,$$

the given exponential function decreases faster as compared to the known function for the activity assessment: A=A₀e^{-λt}.

As an example, the following calculations are for the radioactive isotope Cs-137, where the radioactivity of the freshly unloaded fuel, A₀, is equal to 10¹⁵ Bq/kg.

The half-life for Cs-137 (T_{1/2}) is 30.2 years=9.5×10⁸ seconds. Respectively,

$$λ = \frac{0.693}{{T}_{1 / 2}} = 7.3 \times {10}^{- 10} .$$

Let

$$\frac{H}{{H}_{1}} = {10}^{6} ,$$

that is, H₁<<H, then according to expression (1), A=10¹²×e^{-7.3×10}^{⁻¹⁰}^{×10}^{⁶}^{t}. For time t=10 days=8.6×10⁵ seconds,

$$A = \frac{{10}^{12}}{{e}^{629}} .$$

That is, a significant decrease of the radioisotope activity magnitude will take place.

If we accept that e²⁵=6×10¹⁰, then we obtain

$$A \approx \frac{{10}^{12}}{6 \times {10}^{10}} \approx 1.6 \times {10}^{- 3} Bq \text{/} k g .$$

Such decrease of the activity will occur during 9.4 hours since

$$t = \frac{25}{7.3 \times {10}^{- 4}} = 3.4 \times {10}^{4}$$

seconds. Consequently, the decrease of the Hubble number H₁ in some local region will cause the decrease of activity and, respectively, deactivation of radioactive material.

Consequently, to decrease the activity of radioactive material, it should be placed into the local region where structurization takes place at given flow density Δτ₁, excited in ferromagnetic material at the frequency of electromagnetic oscillations f₁.

It is substantiated theoretically that in order to accelerate deactivation of radioactive material with unexcited nuclei with A₀=10² Bq/kg and lower, the intensity of the fission reaction should be increased. It means that the radioactive material should be placed in the local region with

$$\frac{{H}_{1}}{H} > 1.$$

It is shown that at neutron multiplication under the conditions of

$$\frac{{H}_{1}}{H}$$

and flow Δτ₂ growth, when the specific density of neutrons flux reaches 10²⁰ cm/s, under fulfillment of the criterion

$$p \times {Nv}^{k} ( \frac{{H}_{1}}{H} ) Δ {τ}_{{ρ}_{2}} \geq 4 , 8 \times {10}^{13} Ci ,$$

where ρ is probability, N is the number of atoms, v is the average number of neutrons at decay of one atom v=2.5, K is the stage of decay, Δτ_{ρ2} is the flow from nuclear structurization, spontaneous chain reaction could occur. This should be taken into consideration when determining the amount of radioactive material to be subjected to deactivation lest the critical mass be formed.

It is shown that the activity change in this case equals to

$$A = {A}_{0}^{′} {ⅇ}^{\frac{{H}_{1}}{H} λ t} .$$

Here

$${A}_{0}^{′} = {A}_{0} \frac{{H}_{1}}{H}$$

is increase of the activity in the intensification apparatus due to the spontaneous fission of nuclei. Let

$$\frac{{H}_{1}}{H} = {10}^{7} ,$$

then A=A′₀e^{-λ×10}^{⁷}^{×t}. As an example, the following calculations are for the unexcited nuclei activity decrease for Cs-137 isotope.

A₀=10 Bq/kg;

$${A}_{0}^{′} = {A}_{0} \frac{{H}_{1}}{H} = {10}^{6} Bq \text{/} kg ;$$

A=A′₀e^{-7.2×10}^{⁻¹⁰}^{×10}^{⁷}^{t}=10⁹e^{-7.2×10}^{⁻³}^{t}.

For the time t=10 days=24×3600×10=86×10⁵ seconds,

$$A = \frac{{10}^{9}}{{ⅇ}^{7.3 \times {10}^{- 3} \times 8.6 \times {10}^{5}}} = \frac{{10}^{9}}{{ⅇ}^{6290}} .$$

Meanwhile, even at e²⁰, the activity will already be A=0.9 Bq/kg.

Consequently, in this case, in order to decrease activity, accelerate deactivation of radioactive material, it should be placed into the local region where destructurization takes place at given flow density Δτ₂ excited in ferromagnetic material at the frequency of electromagnetic oscillations of f₂.

The lenses of the space-time flows focusing are known shaped as pyramid, cone, prism described in the monograph A. B. [symbol] , [symbol] . [symbol] , [symbol] [symbol] . [symbol] [symbol] [symbol] , [symbol] ., 2000r. (A. V. Kinderevich, L. I. Kicha, FIELD THEORY. ELEMENTS OF NUMBERS THEORY, Kyiv (2000)). We could not find the most close as to their technical essence apparatuses.

The proposed apparatus for radioactive material treatment 102 (see FIGS. 1, 2, 3, and 4) serves for changing of intensity of physical processes in the local region 220. The elements of the apparatus shaped as prisms 206 as well as cones 216 and 218 formed of ferromagnetic are surrounded by the electrodes 202, 204, 208, 210, 212, and 214. These elements create and focus the flows of space-time, which facilitate acceleration or deceleration of physical processes in the local region. The energy of the external electromagnetic field is absorbed in the elements of the apparatus 102; in this process, spins of ferromagnetic are oriented so that it emits powerful flows of structurization, Δτ₁, or destructurization, Δτ₂. Diagram of the flows Δτ₁ summation is presented in FIG. 4. The specified flows in the local region of the apparatus 102 change the magnitude of the Hubble number and in this way facilitate intensification of the process of radioactive decay of the radioactive material enclosed in the container 222.

### Processing Time Sequence at Embodiment of the Method Together with the Apparatus for its Realization

The container 222 with highly active radioactive waste is loaded into the inner cavity of the apparatus 102 through the cylindrical hole in the second end element 218; and then the adjustable generator of electromagnetic oscillations 104 is turned on. The frequency is set to the frequency of structurization, f₁, at which decrease of intensity of alpha, beta, and gamma radiation begins as monitored by the instruments 106 located directly in the container 222. When the threshold magnitude of the activity is reached, the generator 104 is turned off, and the container 222 with radioactive waste is removed from the inner cavity of the apparatus 102.

In the case of treatment of nuclear power plants fuel elements, which have passed the stage of activity decrease, they are removed from the container 222 and fragmented or ground into smaller pieces. This provides for the possibility of selecting of the amount of radioactive material, which excludes occurrence of chain reaction when treated at the frequency f₂.

After the specified procedure, the container 222 with low active wastes enclosed in it is loaded into the inner cavity of the apparatus 102 for the second time. The adjustable generator of electromagnetic oscillations 104 is turned on; the frequency of destructurization, f₂, is selected, at which activity of the radioactive material somewhat increases, but then irreversible decrease of intensity of alpha, beta, and gamma radiation begins, which is monitored by the instruments 106 located directly in the container 222. When the activity value reaches the magnitude of the environment background, the generator 104 is turned off, and the container 222 with deactivated radioactive wastes is removed from the inner cavity of the apparatus 102 for usage in other ecologically safe technological processes.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. An apparatus for treating radioactive material, said apparatus comprising:
a cylindrical shell electrode having an interior and an inner surface, said cylindrical shell electrode being formed from an electrically conductive material;
a plurality of prism-shaped elements positioned within said interior and around said inner surface of said cylindrical shell electrode, said prism-shaped elements being formed from a ferromagnetic material; and
an inner electrode located within said interior and coupled to said prism-shaped elements such that said prism-shaped elements are not exposed to said interior, said inner electrode being formed from an electrically conductive material.

2. An apparatus according to claim 1, wherein said cylindrical shell electrode and each of said prism-shaped elements are of the same length.

3. An apparatus according to claim 1, wherein each of said prism-shaped elements has a triangular cross section.

4. An apparatus according to claim 3, wherein said triangular cross section includes an acute angle forming an apex that points toward said interior.

5. An apparatus according to claim 3, wherein each of said prism-shaped elements is positioned within said interior such that its apex points toward the longitudinal axis of said cylindrical shell electrode.

6. An apparatus according to claim 1, wherein said plurality of prism-shaped elements comprises at least three prism-shaped elements.

7. An apparatus according to claim 1, wherein said inner electrode defines a cavity within said interior for treatment of radioactive material.

8. An apparatus according to claim 7, further comprising a container sized to fit within said cavity.

9. An apparatus according to claim 1, further comprising:
a conical shell electrode connected to an end of said inner electrode, said conical shell electrode being formed from an electrically conductive material;
a cone-shaped element mounted in said conical shell electrode, said cone-shaped element being formed from a ferromagnetic material; and
an end electrode mounted to said cone-shaped element such that said end electrode does not contact said conical shell electrode, said end electrode being formed from an electrically conductive material.

10. An apparatus according to claim 9, wherein said end electrode is electrically connected to said cylindrical shell electrode.

11. An apparatus according to claim 1, further comprising:
a truncated conical shell electrode connected to an end of said inner electrode, said truncated conical shell electrode being formed from an electrically conductive material, said truncated conical shell electrode having an opening positioned within said interior;
a truncated cone-shaped element mounted in said truncated conical shell electrode, said truncated cone-shaped element being formed from a ferromagnetic material, said truncated cone-shaped element having a conduit formed therein along its central axis; and
an end electrode mounted to said truncated cone-shaped element such that said end electrode does not contact said truncated conical shell electrode, said end electrode being formed from an electrically conductive material, said end electrode having a hole formed therein; wherein
said opening, said conduit, and said hole form a passageway into said interior.

12. An apparatus according to claim 11, wherein said end electrode is electrically connected to said cylindrical shell electrode.

13. A system for treating radioactive material, said system comprising: a treatment apparatus comprising:
a shell electrode having an interior and an inner surface, said shell electrode being formed from an electrically conductive material;
an inner electrode located within said interior, said inner electrode being formed from an electrically conductive material; and
ferromagnetic material located between said inner surface and said inner electrode; and
an AC voltage, adjustable frequency, excitation signal generator having a first output signal node connected to said shell electrode and a second output signal node connected to said inner electrode.

14. A system according to claim 13, further comprising at least one sensor for measuring activity of radioactive material located within said interior of said treatment apparatus.

15. A system according to claim 13, wherein:
said shell electrode is a cylindrical shell electrode;
said ferromagnetic material comprises a plurality of prism-shaped elements positioned within said interior and around said inner surface of said cylindrical shell electrode; and
said inner electrode is coupled to said prism-shaped elements such that said prism-shaped elements are not exposed to said interior.

16. A system according to claim 15, wherein each of said prism-shaped elements has a triangular cross section.

17. A system according to claim 16, wherein each of said prism-shaped elements is positioned within said interior such that its apex points toward the longitudinal axis of said cylindrical shell electrode.

18. A system according to claim 15, wherein said treatment apparatus further comprises:
a conical shell electrode connected to a first end of said inner electrode, said conical shell electrode being formed from an electrically conductive material;
a cone-shaped element mounted in said conical shell electrode, said cone-shaped element being formed from a ferromagnetic material; and
a first end electrode mounted to said cone-shaped element such that said first end electrode does not contact said conical shell electrode, said first end electrode being formed from an electrically conductive material.

19. A system according to claim 18, wherein said treatment apparatus further comprises:
a truncated conical shell electrode connected to a second end of said inner electrode, said truncated conical shell electrode being formed from an electrically conductive material, said truncated conical shell electrode having an opening positioned within said interior;
a truncated cone-shaped element mounted in said truncated conical shell electrode, said truncated cone-shaped element being formed from a ferromagnetic material, said truncated cone-shaped element having a conduit formed therein along its central axis; and
a second end electrode mounted to said hollow truncated cone-shaped element such that said second end electrode does not contact said truncated conical shell electrode, said second end electrode being formed from an electrically conductive material, said second end electrode having a hole formed therein; wherein
said opening, said conduit, and said hole form a passageway into said interior.

20. A method for the treatment of radioactive material, said method comprising:
placing radioactive material into a treatment tank comprising an outer shell electrode, an inner electrode, and ferromagnetic material located between said outer shell electrode and said inner electrode;
generating an AC voltage excitation signal having a frequency equal to the frequency of structurization of said ferromagnetic material; and
applying said excitation signal to said outer shell electrode and said inner electrode to decrease activity of said radioactive material, resulting in processed radioactive material.

21. A method according to claim 20, further comprising:
monitoring radioactive activity of said processed radioactive material; and
removing said excitation signal when radioactive activity of said processed radioactive material reaches a threshold value.

22. A method according to claim 20, wherein applying said excitation signal decreases intensity of alpha, beta, and gamma radiation of said radioactive material.

23. A method according to claim 20, further comprising:
generating a second AC voltage excitation signal having a frequency equal to the frequency of destructurization of said ferromagnetic material; and
applying said second excitation signal to said outer shell electrode and said inner electrode to decrease activity of said processed radioactive material.

24. A method according to claim 23, further comprising fragmenting said processed radioactive material prior to applying said second excitation signal.

25. A method according to claim 23, wherein applying said second excitation signal decreases intensity of alpha, beta, and gamma radiation of said processed radioactive material.
